(19) United States
(12) Patent Application Publication
(10) Pub. No.: US 2015/0132984 A1
(43) Pub. Date: May 14, 2015

(54) MOBILE OTP SERVICE PROVIDING SYSTEM

(71) Applicant: SAFERZONE CO., LTD., Daejeon (KR)

(72) Inventors: Chul Su KIM, Daejeon (KR); Won Jang SON, Gyeonggi-do (KR)

(73) Assignee: SAFERZONE CO., LTD., Daejeon (KR)

(21) Appl. No.: 14/134,811

(22) Filed: Dec. 19, 2013

(30) Foreign Application Priority Data
Nov. 14, 2013 (KR) 10-2013-0138250

(51) Int. Cl. H01R 13/627; H01R 13/648

(52) U.S. Cl. CPC H01R 13/627; H01R 13/648
USPC 439/345; 439/607.01

(57) ABSTRACT

A mobile OTP system providing system is provided, in that it performs security token and OTP management functions, it generates an OTP having high security level in hardware by using a mobile OTP device for performing a security data storage function of encoding and decoding data during data storage, and it generates OTPs necessary for a plurality of services by using one mobile OTP device, thereby safely and easily utilizing it by means of the user.

### CROSS REFERENCE

Applicant claims foreign priority under Paris Convention to Korean Patent Application No. 10-2013-0138250, filed 14 Nov. 2013, with the Korean Intellectual Property Office, where the entire contents are incorporated herein by reference.

### BACKGROUND OF THE INVENTION

1. Field of the Invention

The present invention relates to a mobile OTP service providing system and, more particularly, to a mobile OTP system providing system in that it performs security token and OTP management functions, it generates an OTP having high security level in hardware by using a mobile OTP device for performing a security data storage function of encoding and decoding data during data storage, and it generates OTPs necessary for a plurality of services by using one mobile OTP device, thereby safely and easily utilizing it by means of the user.

2. Description of the Related Art

With the development of information and communication technologies, the non-face-to-face transactions such as network banking, corporate affairs, games and other using a network are activated. Accordingly, the non-face-to-face transaction provider authenticates as to whether the user is a valid trader or not, so as to prepare for an accident.

Generally, as the most common way capable of authenticating the user connected through the network in the non-face-to-face transaction, the authentication manner using user ID and password is widely used. However, since the ID/PW manner is easily exposed to outside, it is used for identifying the trader, not for transaction authentication on the non-face-to-face transaction.

In case of the authentication method using the certificate, the medium (for example, a computer), in which the certificate is stored, can be hacked or the non-face-to-face transaction can be performed through a terminal, on which a keyboard hacking program is installed. Accordingly, it is difficult for the certificate to be used for the transaction authentication on the non-face-to-face transaction.

In order to supplement the vulnerability of the security owing to the above certificate, an OTP (One Time Password) is used. In case of the OTP, after the trader exchanges and shares a fixed seed value, which is dynamically determined, at the moment of generating at least one fixed seed value and the password, the trader substitutes the fixed seed value and the dynamic seed value determined at the time of the non-face-to-face authentication with the code generation algorithm (for example, hash function), so that it can generate the OTP capable of using once, thereby exchanging and certifying the generated OTP. Even if the OTP is exposed to outside, since the same OTP cannot be reused, it is used as a safe authentication means against the hacking in comparison with other authentication means.

The OTP technologies are divided into a hardware-based OTP used in a bank, an OPT device or USIM (Universal Subscriber Identity Module)-based OPT, and a mobile OTP having an OTP generation algorithm and implemented by software in a cell phone.

The hardware-based OTP used in the banks has the highest security in terms of the environment and a double authentication is possible by using a separate hardware. However, the cost is expensive owing to the separate hardware implementation. Also, since a separate power supply is used therein, the power supply must be replaced again after a period of time.

For example, as a prior art capable of generating the hardware-based OTP, Korean patent publication No. 10-2013-0025420 discloses an OTP generating method and a terminal device thereof.

In the OTP generating method and the terminal device thereof, the terminal device includes a PIN(Personal Identification Number) input unit for receiving a PIN from a user through an input module, a PIN transmission unit for transmitting the PIN to an OTP card through an NFC(Near Field Communication) module, a seed reception unit for receiving a seed value corresponding to a PIN authentication result from the OTP card through the NFC module, a time acquisition unit for acquiring a standard time value based on a point in which a seed value is received, an OTP generating unit for generating an OTP through the received seed value and the acquired time value, and an OTP output unit for outputting the OTP generated through the output module.

In the OTP generating method and the terminal device thereof, at least one seed value corresponding to the PIN inputted form the user and the time value corresponding to the standard time are substituted with the OTP generation algorithm so as to generate the OTP having a specified digit number.

However, in the conventional OTP generating method and the terminal device thereof, since a GMT (Greenwich Mean Time) reference value is included in the OTP card and the terminal device and the time value capable of converting into a code for instantly substituting with the OTP generation algorithm and the rules for changing and converting the time value should be loaded thereon, it is necessary to maintain exact time information all the time. Also, there is a problem in that the OTP authentication is impossible in the event of a time value failure.

On the other hand, in case of the OTP using the USIM, there are no extra costs and loss of power supply. However, since the communication firms handle the USIM itself, the financial corporations are burden by their independent services.

Also, in case of the hardware-based OTP, since the OTP unit generates the OTP on one service, a plurality of the OTP units should be equipped, when the OTP is used in various services. For example, where the user uses the OTP on the plurality of the services, it is issued the OTP unit in every service providers and then, the OTP authentication is performed by using the OTP issued from the corresponding service provider during the using of the corresponding service. Therefore, the user should be issued the corresponding OTP unit from the organization of providing the corresponding service when the service necessary for the OTP authentication is added. Also, after the OTP units by the service are equipped, whenever the service is changed, it should use the OTP unit corresponding to the changed service.

In case of the mobile OTP through the implementation of the mobile terminal, since it is implemented in software through the execution of the OTP generation algorithm, the dissemination is easy. However, there is a security environment problem such as a memory hacking and no double authentication. Accordingly, the enhanced user authentication method is needed.

### SUMMARY OF THE INVENTION

Accordingly, the present invention has been made keeping in mind the above problems occurring in the prior art, and an object of the present invention is to provide a mobile OTP service providing system in that it performs security token and OTP management functions, it generates an OTP having high security level in hardware by using a mobile OTP device for performing a security data storage function of encoding and decoding data during data storage, and it generates OTPs necessary for a plurality of services by registering a plurality of service addresses in one mobile OTP device and changing a seed value by service address, and it provides a time information from a mobile device, so that a separate means or algorithm of acquiring a standard time information is not required.

In accordance with an aspect of the present invention, there is provided a mobile OTP service providing system, comprising: an OTP mobile device for storing a seed value, an unique serial number, and a service address information and changing the seed value by service address through a service analysis according to OTP generation request signals so as to generate an OTP; a mobile device for storing mobile OTP management applications for controlling an OTP generation, an OTP transmission, and an OTP verification, generating an OTP generation request signal through the mobile OTP management applications according to a service requested by a user, transmitting it to the mobile OTP device, and displaying the OTP received from the mobile OTP device thereon; a service server for receiving a user identification information and the unique serial number of the mobile OTP device through the mobile OTP management applications so as to perform an registration of the OTP, performing a user authentication and a OTP verification by using the user identification information and the OTP during service request of the corresponding user, and then providing the corresponding service; and an OTP verification server for storing an unique serial number classified by the mobile OTB device, the user identification information, and the seed value, performing the user authentication and the OTP verification when the user identification information and the OTP are received from the service server, and then transmitting the completion signal or failure signal of the OTP verification to the service server.

Preferably, the mobile device transmits the OTP generation request signal together with the service address and the time information to the mobile OTP device.

Preferably, the mobile device connects to the service server through the mobile OTP management applications, transmits the service address to the mobile OTP device when the completed verification signal on the user authentication is received from the service server, and the mobile OTP device registers the service address.

Preferably, the mobile OTP service providing system further comprises an OTP management server for providing an interface for administrator capable of storing and managing the seed value, the unique serial number, and the user identification information inputted at the beginning thereof.

Preferably, the mobile OTP device comprises: an OTP management module for generally controlling the register and generation of the OTP, the service analysis, and the encryption process; a storage management module and a memory management module for allocating storage areas of the storage and the memory by means of the program or the data and managing all of the works converted; a token management module for generally controlling all processes including a setting of a security token, a token data recording, and control activities during token life cycle; an access control module used to define or limit the permissions of gaining access to the mobile OTP device and performing a limit function for allowing only the allowed administrator or programs to be gained access to the storage information or the memory information; an encryption module for encrypting the data transmitted to and received from the mobile OTP device through an encryption; and a chip operating module for generally controlling the operations of each module so as to perform various application programs inside the mobile OTP device.

Preferably, the OTP management module comprises: a service management unit for changing and managing the seed value classified by the service address through the analysis of the service; an OTP registration unit for registering the seed value by the service address, the unique serial number, and the service address information; a first OTP generation unit for generating the OTP at a predetermined distance of time based on a synchronized time information between the service server and the mobile OTP device; a second OTP generation unit for generating the OTP based on the same count value between the service server and the mobile OTP device; and a cipher engine unit for encrypting the OTP generated from the first OTP generation unit or the second OTP generation unit.

Preferably, the service server comprises: a RADIUS (Remote Authentication Dial-in User Services) server for performing the user authentication by using the user information having the user identification information and the password during the service request from a client terminal connected to the mobile device; and a user DB associated with the RADIUS server and storing the user information and the OTP information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a mobile OTP service providing system according to one embodiment of the present invention;

FIG. 2 is a block diagram illustrating a configuration of the mobile OTP device of FIG. 1;

FIG. 3 is a block diagram illustrating a configuration of the OTP management module of FIG. 2;

FIG. 4 is a flow chart illustrating a registration process of an OTP by means of a mobile OTP service providing system according to one embodiment of the present invention; and

FIG. 5 is a flow chart illustrating a use process of an OTP by means of a mobile OTP service providing system according to one embodiment of the present invention.

### DESCRIPTION OF THE PREFERRED EMBODIMENTS

The present invention may be embodied in many different forms without departing from the spirit and significant characteristics of the invention. Therefore, the embodiments of the present invention are disclosed only for illustrative purposes and should not be construed as limiting the present invention.

It will be understood that, although the terms first, second, etc. may be used herein to describe various elements, these elements should not be limited by these terms.

These terms are only used to distinguish one element, from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween.

In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a,” “an” and “the” are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this invention belongs.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, preferred embodiments of the present invention will be described in detail with reference to the attached drawings. The same reference numerals will be used throughout the different drawings to designate the same or similar components, and the repetition of the same explanation for these components will be skipped.

If in the specification, detailed descriptions of well-known functions or configurations would unnecessarily obscure the gist of the present invention, the detailed descriptions will be omitted.

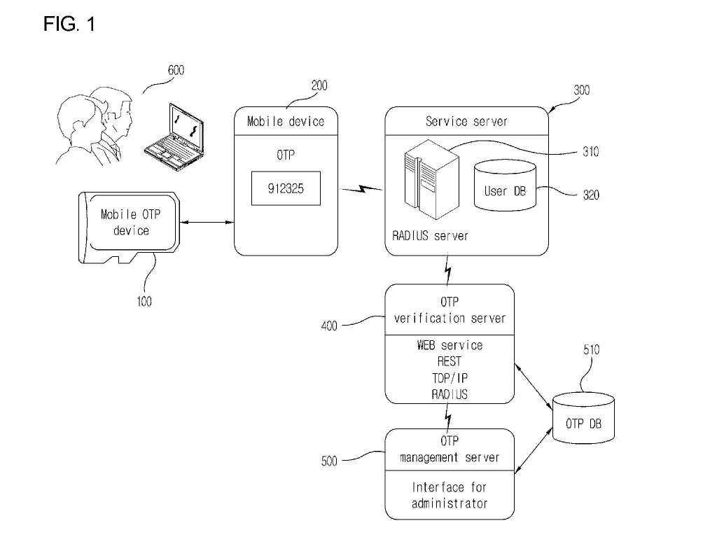

FIG. 1 is a block diagram illustrating a mobile OTP service providing system according to one embodiment of the present invention.

Referring to FIG. 1, the mobile OTP service providing system includes a mobile OTP device 100, a mobile device 200, a service server 300, an OTP verification server 400, and an OTP management server 500.

The OTP mobile device 100 serves to store a seed value, an unique serial number, and a service address information having an URL, an identifier, an IP address, and a web service address etc., and change the seed value by service address through a service analysis according to OTP generation request signals so as to generate the OTP.

The mobile OTP device 100 is any device for performing security token and OTP management functions and performing a security data storage function for encryption and decryption during data storage. It may be implemented in the form of a removable disk such as an USB memory, a CF (Compact Flash) card, a SD card and a smart card and so on.

The mobile device 200 serves to store mobile OTP management applications for performing various control functions on an OTP generation, an OTP transmission, and an OTP verification and connect the mobile OTP device 100 with the service server 300, when the mobile OTP management applications are executed by the user, so as to perform an user authentication function, a service address register function, an OTP generation request function, and an OTP display function.

Also, the mobile device 200 serves to bring the unique serial number from the mobile OTP device 100, transmit the unique serial number with identification information of the user to the service server 300 so as to perform the user verification and the unique serial number verification, and register the service address of the corresponding service server 300 on the mobile OTP device 100 when the completed verification signal is transmitted from the service server 300.

The mobile OTP device 100 serves to store the registered serves address therein. Here, the verification process on the pre-registered service address based on the stored address list can be omitted.

In addition, the mobile device 200 serves to execute the mobile OTP management applications when the OTP request signals are transmitted from the service server 300, transmit the OTP generation request signals together with the service address and the time information to the mobile OTP device 100, and display the OTP transmitted from the mobile OTP device 100 thereon.

This mobile device 200 can be connected to the service server 300 via a network. The mobile device 200 as a wireless terminal capable of displaying the OTP is not limited to the kind thereof. The mobile device 200 may be a portable communication device or a fixed communication device such as a PCS (Personal Communication System), a PHS (Personal Handy phone System), a note book, a laptop computer, a mobile phone, a smart phone, a PDA (Personal Digital Assistant), a PMP (Portable Multimedia Player), a MP3 (MPEG-3) player, a tablet PC etc.

The service server 300 serves to provide an Internet banking service, a groupware of company and ERP (Enterprise Resources Planning) services, a game service, an Internet portal service and so on. The service server 300 serves to receive the identification information of the user and the unique serial number of the mobile OTP device 100 during the registration of the OTP so as to perform the user verification, verify the identification information of the user and the unique serial number through an OTP verification server 400, and then, transmit the completed verification signals to the mobile device 200.

Also, in the service server 300, when the ID and the password are inputted from a client terminal of the client having the mobile device 200, the client having the mobile device 200 requests the OTP by means of the client terminal 600. Then, the client terminal 600 serves to allow the mobile OTP management applications to be executed in the mobile device 200. The mobile OTP management application serves to transmit the service address and the time information to the mobile OTB device 100 and transmit the OTP generation request signal thereto.

If the OTP displayed on the mobile device 200 is inputted through the client terminal 600, the service server 300 serves to transmit the user identification information and the OTP to the OTP verification server 400 and provide the service requested by the client to the client terminal 600 when the completed verification signal is transmitted from to the OTP verification server 400.

The service server 300 includes a RADIUS (Remote Authentication Dial-in User Services) server. Accordingly, it can execute the user identification and authentication by using the user identification information (ID) or the password and IP address information etc. during the connection request of the remote client. Also, the service server 300 further includes a user DB 320 associated with the RADIUS server 310.

The OTP verification server 400 serves to store the unique serial number classified by the mobile OTB device 100, the user identification information, and the seed value, transmit the user identification information and the OTP according to the request of the service server 300 so as to perform the OTP verification, and then transmit the completed verification signals to the service server 300. The OTP verification server 400 has any communication function based on a web service, a REST support, a TCP/IP, and a RADIUS

The OTP management server 500 serves to provide an interface for administrator capable of storing and managing the seed value, the unique serial number, and the user identification information inputted at the beginning thereof. The OTP management server 500 serves to perform an administrator account management function, device registration/bulk registration/disusing functions, time/event amending functions, and Radius server registration functions and so on. In addition, the OTP management server 500 can further include any function of showing the used statistical information of the OTP.

The OTP verification server 400 and the OTP management server 500 serve to store the unique serial number-Seed value classified by the OTP mobile device 100, the administrator account, the amended information, the information on the service server etc. in the OTP DB 510.

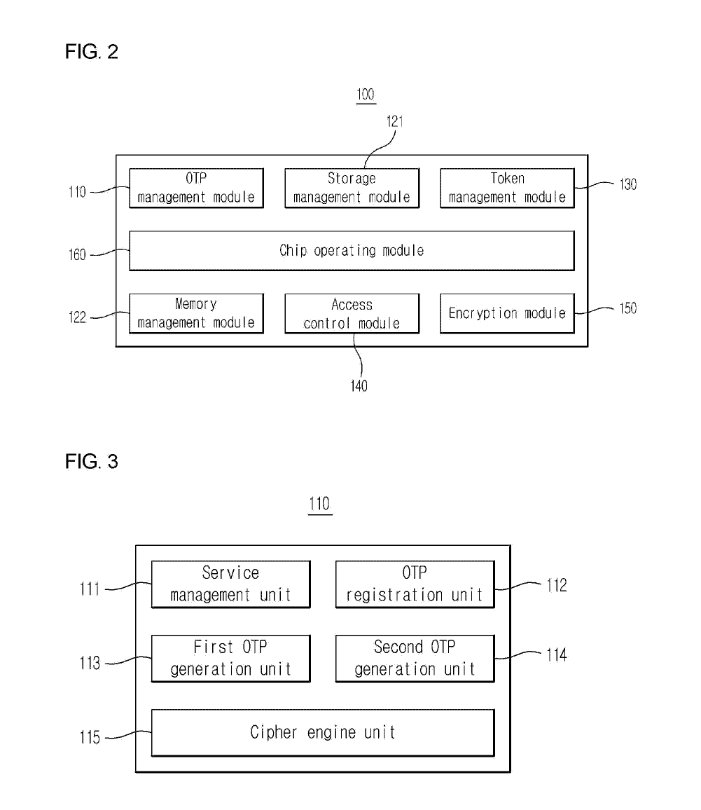

FIG. 2 is a block diagram illustrating a configuration of the mobile OTP device of FIG. 1.

Referring to FIG. 2, the mobile OTP device 100 includes an OTP management module 110, a storage management module 121, a memory management module 122, a token management module 130, an access control module 140, an encryption module 150, and a chip operating module 160.

The OTP management module 110 serves to generally control the register and generation of the OTP, the service analysis, and the encryption process.

The storage management module 121 and the memory management module 122 serve to allocate the storage areas such as the storage and the memory by means of the program or the data and manage all of the works returned. That is, the storage management module 121 and the memory management module serve to manage the used state of the storage areas and allocate the storage areas according to the request of each program.

The token management module 130 serves to generally control all processes such as a setting of a security token, a token data recording, and control activities during token life cycle. The token management module 130 serves to perform backup/copy/restore operations and update operations on the data information such as a public/private key management, a certificate management, personal identification number (PIN) generation and installation, an user personal information recording, a public key/ private keys, certificates, a personal identification number and an user personal information and the like.

The access control module 140 is used to define or limit the permissions of gaining access to the mobile OTP device 100 and serves to perform a limit function for allowing only the allowed administrator or programs to be gained access to the resource information such as the storage or the memory and so on.

The encryption module 150 serves to automatically encrypt the data transmitted to and received from the mobile OTP device 100 by using AES/RSA encryption methods.

The chip operating module 160 serves to provide interfaces capable of using modules implemented in hardware such as the memory management module 122, the access control module 140, and the encryption module 150 and manage the programs in such a manner that the application programs such as the OTP management module 110, the storage management module 121, and the token management module 130 can utilize the hardware resources.

FIG. 3 is a block diagram illustrating a configuration of the OTP management module of FIG. 2.

Referring to FIG. 3, the OTP management module 110 includes a service management unit 111, an OTP registration unit 112, a first OTP generation unit 113, a second OTP generation unit 114, and a cipher engine unit 115.

The service management unit 111 serves to analyze the service performed by the corresponding service server 300 by using the information of the service address so as to change and manage the seed value classified by the service address.

The OTP registration unit 112 serves to register the seed value by the service address, the unique serial number, and the service address information.

The first OTP generation unit 113 serves to generate the OTP of a time synchronization method according to the request of the mobile OTP management application and the second OTP generation unit 114 serves to generate the OTP of an event synchronization method according to the request of the mobile OTP management application.

The cipher engine unit 115 serves to encrypt the OTP generated from the first OTP generation unit 113 or the second OTP generation unit 114 to be outputted.

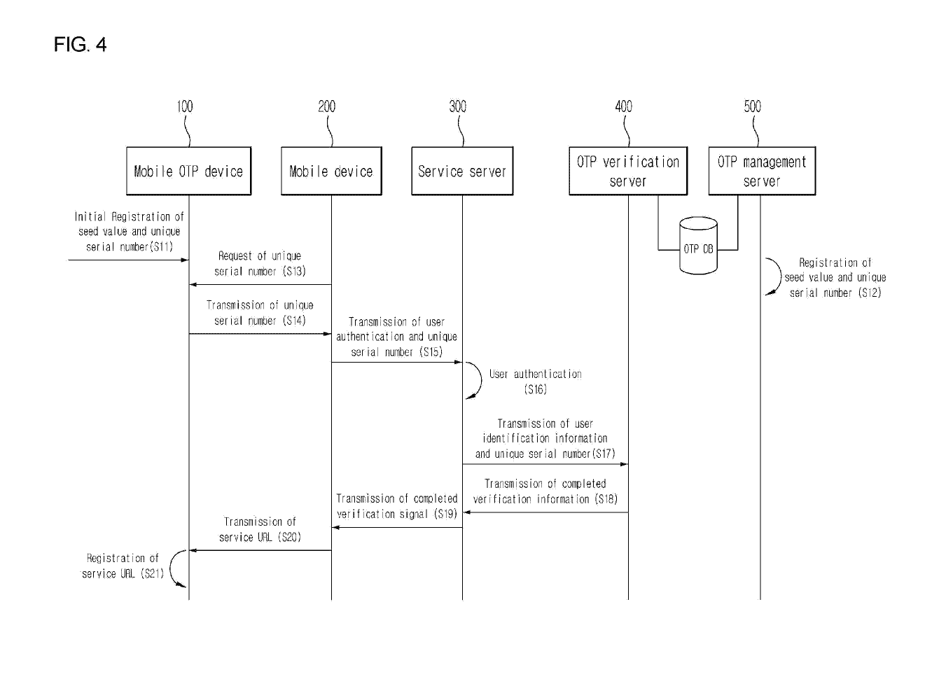

FIG. 4 is a flow chart illustrating a registration process of an OTP by means of a mobile OTP service providing system according to one embodiment of the present invention.

In the registration process of the OTP by means of the mobile OTP service providing system according to one embodiment of the present invention, the seed value and the unique serial number are initially registered in the OTP mobile device 100 (S11) and the OTP management server 500 serves to register the seed value and the unique serial number classified by the mobile OTP device (S12).

The mobile device 200 requests the unique serial number from the mobile OTP device 100 and the mobile OTP device 100 transmits the unique serial number to the mobile device 100(S13 and S14).

The mobile device 200 is connected to the service server 300 via a network by mean of the mobile OTP management application and transmits the unique serial number of the mobile OTP device 100 with the identification information of the user to the service server 300 (S15). The service server 300 serves to perform the user verification and transmit the identification information of the user and the unique serial number to the OTP verification server 400 (S16 and S17).

The OTP verification server 400 serves to perform the verification of the user identification information and the unique serial number and transmit the verification result thereof to the service server 300 (S 18) and the service server 300 serves to transmit the completed verification signals to the mobile device 200 according to the verification result received from the OTP verification server 400 (S19).

The mobile device 200 serves to transmit the verified service address of the service server 300 to the mobile OTP device 100 and the mobile OTP device 100 serves to register the service address received from the mobile device 200(S20 and S21).

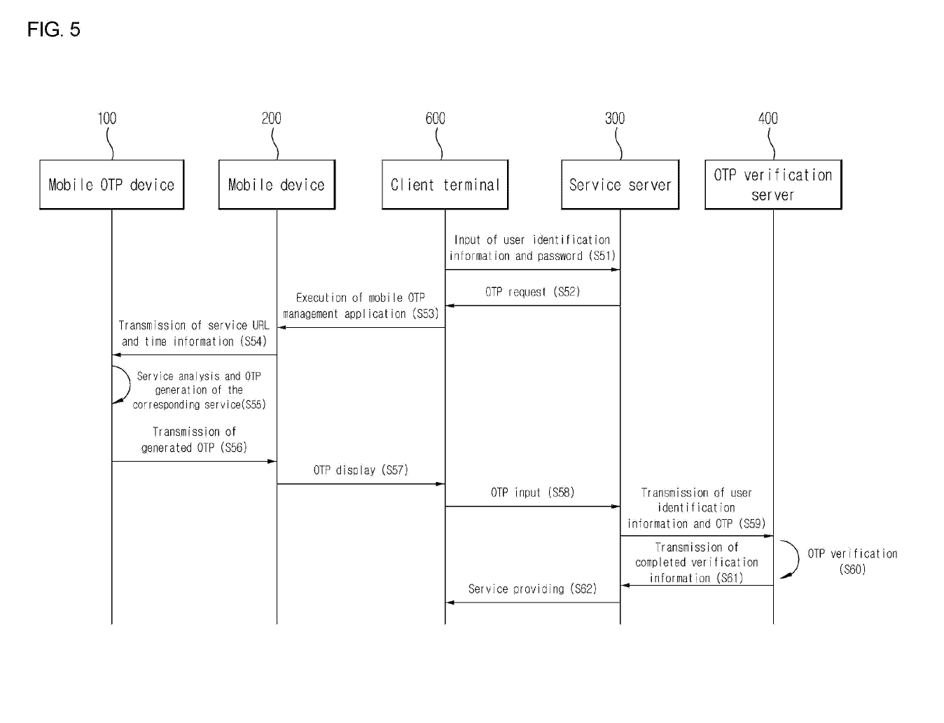

FIG. 5 is a flow chart illustrating a use process of an OTP by means of a mobile OTP service providing system according to one embodiment of the present invention.

In the use process of the OTP by means of the mobile OTP service providing system according to one embodiment of the present invention, when the ID and the password are inputted from the client terminal 600 having the mobile device 200 and the service is requested through the service server 300, the service server 300 asks the client terminal 600 for the OTP (S51 and S52).

The client terminal 600 serves to execute the mobile OTP management applications of the mobile device 200 and the mobile OTP management applications serve to transmit the service address and the time information to the mobile OTB device 100 (S53 and S54).

The mobile OTB device 100 serves to perform the service analysis by using the service address and then, change the seed value according to the corresponding service address, and generate the OTP through the changed seed value and the time information provided from the mobile device 200 (S55).

Thus, since the mobile OTP device 100 provides the time information from the mobile device 200, the standard time information acquiring means for acquiring the time information is not required.

The OTP mobile device 100 serves to transmit the generated OTP to the mobile device 200 and the mobile device 200 serves to receive the OTP to be displayed by using the display means (S56 and S57). Accordingly, the client terminal serves to input the OTP displayed on the mobile device 200 and the service server 300 serves to transmit the inputted OTP and the user identification information to the OTP verification server 400, so that the OTP verification server 400 verifies the OTP (S58, S59, S60).

The OTP verification server 400 serves to transmit the completion signal or failure signal of the OTP verification to the service server 300 (S61). The service server 300 serves to provide the service requested by the client terminal 600 when the completed verification signal is transmitted from the OTP verification server 400 (S62).

Accordingly, according to the mobile OTP service providing system and, it generates the OTP having high security level in hardware by using the mobile OTP device for performing the security data storage function of encoding and decoding data during data storage, and it generates OTPs necessary for the plurality of services by registering the plurality of service addresses in one mobile OTP device and changing the seed value by the service address, and it provides the time information from the mobile device, so that the separate means or algorithm of acquiring a standard time information is not required, thereby reducing the costs thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A mobile OTP service providing system, comprising:
an OTP mobile device for storing a seed value, an unique serial number, and a service address information and changing the seed value by service address through a service analysis according to OTP generation request signals so as to generate an OTP;
a mobile device for storing mobile OTP management applications for controlling an OTP generation, an OTP transmission, and an OTP verification, generating an OTP generation request signal through the mobile OTP management applications according to a service requested by a user, transmitting it to the mobile OTP device, and displaying the OTP received from the mobile OTP device thereon;
a service server for receiving a user identification information and the unique serial number of the mobile OTP device through the mobile OTP management applications so as to perform an registration of the OTP, performing a user authentication and a OTP verification by using the user identification information and the OTP during service request of the corresponding user, and then providing the corresponding service; and
an OTP verification server for storing an unique serial number classified by the mobile OTB device, the user identification information, and the seed value, performing the user authentication and the OTP verification when the user identification information and the OTP are received from the service server, and then transmitting the completion signal or failure signal of the OTP verification to the service server.

2. The mobile OTP service providing system of claim 1, wherein the mobile device transmits the OTP generation request signal together with the service address and the time information to the mobile OTP device.

3. The mobile OTP service providing system of claim 1, wherein the mobile device connects to the service server through the mobile OTP management applications, transmits the service address to the mobile OTP device when the completed verification signal on the user authentication is received from the service server, and the mobile OTP device registers the service address.

4. The mobile OTP service providing system of claim 1, further comprising an OTP management server for providing an interface for administrator capable of storing and managing the seed value, the unique serial number, and the user identification information inputted at the beginning thereof.

5. The mobile OTP service providing system of claim 1, wherein the mobile OTP device comprises:
an OTP management module for generally controlling the register and generation of the OTP, the service analysis, and the encryption process;
a storage management module and a memory management module for allocating storage areas of the storage and the memory by means of the program or the data and managing all of the works converted;
a token management module for generally controlling all processes including a setting of a security token, a token data recording, and control activities during token life cycle;
an access control module used to define or limit the permissions of gaining access to the mobile OTP device and performing a limit function for allowing only the allowed administrator or programs to be gained access to the storage information or the memory information;
an encryption module for encrypting the data transmitted to and received from the mobile OTP device through an encryption; and
a chip operating module for generally controlling the operations of each module so as to perform various application programs inside the mobile OTP device.

6. The mobile OTP service providing system of claim 5, wherein the OTP management module comprises:
a service management unit for changing and managing the seed value classified by the service address through the analysis of the service;
an OTP registration unit for registering the seed value by the service address, the unique serial number, and the service address information;
a first OTP generation unit for generating the OTP at a predetermined distance of time based on a synchronized time information between the service server and the mobile OTP device;
a second OTP generation unit for generating the OTP based on the same count value between the service server and the mobile OTP device; and
a cipher engine unit for encrypting the OTP generated from the first OTP generation unit or the second OTP generation unit.

7. The mobile OTP service providing system of claim 1, wherein the service server comprises:
a RADIUS (Remote Authentication Dial-in User Services) server for performing the user authentication by using the user information having the user identification information and the password during the service request from a client terminal connected to the mobile device; and
a user DB associated with the RADIUS server and storing the user information and the OTP information.

8-14. (canceled)
